(19) United States
(12) Patent Application Publication
(10) Pub. No.: US 2023/0241697 A1
(43) Pub. Date: Aug. 3, 2023

(54) Rotary Grinding Wheel For Shaping And Sharpening Saw Blade Teeth

(71) Applicant: James Dimond, Battle Creek, MI (US)

(72) Inventor: James Dimond, Battle Creek, MI (US)

(21) Appl. No.: 18/104,515

(22) Filed: Feb. 1, 2023

Related U.S. Application Data
(60) Provisional application No. 63/305,774, filed on Feb. 2, 2022.

(51) Int. Cl. B23D 63/14

(52) U.S. Cl. CPC B23D 63/14

(57) ABSTRACT

An apparatus that is meant to facilitate the sharpening of many saw teeth quickly. The unique grinding wheel shapes blade teeth by grinding in a crisscross fashion. The apparatus renews worn or damaged saw blade teeth and is able to shape new sharpened teeth on saw blades with no teeth.

### RELATED APPLICATION

This application is a continuation-in-part to U.S. 63/305,774 filed Feb. 02, 2022 and incorporates the filing in its entirety.

### FIELD OF THE INVENTION

The present subject matter relates to a rotary grinding wheel for shaping and sharpening saw blade teeth.

### BACKGROUND OF THE INVENTION

An object of this invention is to allow saw blades to be used over and over. Blades for both reciprocating and oscillating saws, for example, can wear out or break, yet there is often more metal left in the blade to shape newly sharpened teeth

Another objective of this invention is to make a saw blade out of a strip of metal or other material.

Another objective of this invention is to make the task of sharpening a saw blade more efficient. Traditionally, a person would throw away damaged or worn reciprocating and oscillating saw blades because the only way to sharpen the saw blades would be to file one side of one tooth at a time, which is extremely tedious and time consuming.

Another objective of this invention is to allow a rotary grinding wheel to shape teeth on both oscillating saw blades and reciprocating saw blades. Both types of blades use similar teeth.

Another objective of this invention is to utilize an electric motor to spin the rotary grinding wheel at a speed necessary for shaping and sharpening saw blade teeth.

Another objective of some embodiments of this invention is to shape one side of the blade teeth by pressing a saw blade against a rotating row of staggered angled grinding surfaces to a desired depth. The saw blade can then be moved to shape an opposing side of the blade teeth when pressing the saw blade into the rotary grinding wheel.

Another objective of this invention is to quickly shape a row of teeth with sharp points on worn, broken, or new saw blades.

Another objective of this invention is to be able to use various abrasives on the grinding surfaces depending on the material being shaped, in order to allow shaping of a variety of materials.

### Relevant Prior Art

US 4,019,408, Idel, Apr. 26, 1977, Method of Grinding Band Saw Teeth
US 4,357,841, Mote, Nov. 9, 1982, Automatic Grinding Attachment for Saw Grinders
US 4,436,000 Lenard et al., Mar. 13, 1984, Sharpening Machine for Saws
US 5,038,639, Emter, Aug. 13, 1991, Saw Blade Top and Face Grinder
US 5,048,236, Williams, Sept. 17,1991, Saw Blade Tooth Grinder for Saws
US 6,681,655, Rein, Jan. 27, 2004, Grinding Attachment and Saw-Blade Grinding Machine with an HF Spindle
US 7,033,254, Lenard et al., Apr. 25, 2006, Grinding Machine for Double-Sided Grinding of Saw Tooth Edges
US 9,233,428, Williams et al., Jan. 12, 2016, Computer Controlled Multiple Axis Grinding Machine for Grinding Saw Blades
US 2004/0171334 Turnac et al., Sept. 2, 2004, Saw Blade Sharpening Machine

### Improvements Over the Prior Art

One advantage of this invention is that the rotary grinding wheel is able to sharpen many saw teeth quickly.

Another advantage of some embodiments of this invention is that each set of angled grinding surfaces is staggered to a desired distance and forms one side of each tooth in the row of teeth.

Each set of angled grinding surfaces is also taller than the desired height of the teeth being shaped. This unique grinding wheel design shapes blade teeth grinding in a crisscross way, forming one side of a plurality of saw teeth at a time.

This creates sharper teeth than a grinding wheel that makes fully formed teeth in one pass because the valley of the inverted “V” shape on a grinding wheel that could make fully formed teeth in one pass inherently has a radius to it because of the way grinding wheels are made. Even if a perfect “V” could be made on the grinding wheel, once an abrasive medium is applied it would create a radius at the bottom of the “V.”

Another advantage is that certain embodiments of the invention shape multiple sharpened saw blade teeth one side of the teeth at a time.

Another advantage is that the invention shapes new sharpened teeth on saw blades with no teeth.

Another advantage is that the invention renews worn or damaged saw blade teeth.

Another advantage is that the invention can be mounted directly to a rotary tool or mounted in an apparatus to feed a blade into the rotary grinding wheel.

### SUMMARY OF THE INVENTION

The following detailed description is of the best currently contemplated modes of carrying out exemplary embodiments of the invention. The description is not to be taken in a limiting sense but is made merely for the purpose of illustrating the general principles of the invention.

FIG. 1 is a side view of a rotary grinding wheel 8 for shaping and sharpening saw blade teeth. The rotary grinding wheel 8 spins by using a motor. The rotary grinding wheel 8 spins at a speed necessary for shaping saw blade teeth.

The rotary grinding wheel 8 can be mounted using a shank 6 in any way that allows for shaping saw blade teeth. A plurality of grinding blades 2 are dispersed evenly on a body 4 in such a way that the grinding blades 2 correspond to one side of desired saw blade teeth.

The body 4 is of sufficient size to provide support to the grinding blades 2. Angular surfaces 10 are on both sides of the grinding blades 2. All angular surfaces 10 are coated in an abrasive such as but not limited to CBN abrasive.

The rotary grinding wheel may be made of hardened steel or any other suitable material. FIGS. 1-5 show a scaled example tooth pattern of 24 teeth per inch, but other tooth patterns could be used as well.

FIGS. 2 and 3 show the operation of the rotary grinding wheel from FIG. 1. FIG. 2 is a side view of a rotary grinding wheel 14 for shaping and sharpening saw blade teeth along with a side view of a saw blade 12 after one pass with the rotary grinding wheel 14.

One side of each tooth 18 is ground in the saw blade 12. A second pass to shape another side of the teeth 18 will grind teeth in space 20. The saw blade 12 is pressed into the spinning rotary grinding wheel 14 in a direction indicated by arrow 28.

All angular surfaces 16 are coated in an abrasive. A plurality of grinding blades 26 are dispersed evenly on a body 22 in such a way that the grinding blades 26 correspond to one side of desired saw blade teeth.

The body 22 is of sufficient size to provide support to the grinding blades 26. A shank 24 supports the rotary grinding wheel 14 and provides a mounting point for use with a motor.

FIG. 3 is a side view of a rotary grinding wheel 34 for shaping and sharpening saw blade teeth along with a side view of a saw blade 30 after two passes with the rotary grinding wheel. The saw blade 30 has been shifted laterally from a position in FIG. 2 to create the second side of teeth 32.

The saw blade 30 is pressed into the spinning rotary grinding wheel 34 in a direction indicated by arrow 44. All angular surfaces 36 are coated in an abrasive. A plurality of grinding blades 40 are dispersed evenly on a body 42 in such a way that the grinding blades 40 correspond to one side of desired saw blade teeth.

The body 42 is of sufficient size to provide support to the grinding blades 40. A shank 38 supports the rotary grinding wheel 34 and provides a mounting point for use with a motor.

FIG. 4 is a side view of an alternative embodiment of a rotary grinding wheel in which a saw blade would need to be flipped horizontally to make a second side of saw teeth. Angular surfaces 50 are on one side of grinding blades 48.

All angular surfaces 50 are coated in an abrasive material. Grinding blades 48 are evenly spaced on a body 54. A body 54 is of sufficient size to give support to the grinding blades 48. A shank 52 supports the rotary grinding wheel and provides a mounting point for use with a motor.

FIG. 5 is a side view of an alternative embodiment of a rotary grinding wheel in which the full set of saw teeth can be formed and sharpened in one pass. Angular surfaces 62 are on both sides of grinding blades 60.

Grinding blades 60 are evenly and continuously spaced. All angular surfaces 62 are coated in an abrasive material. A shank 56 supports the rotary grinding wheel and provides a mounting point for use with a motor.

FIG. 6 is a front view of an alternative embodiment of a rotary grinding wheel in which a single tooth can be added to a piece of metal or saw blade. The single point grinding wheel can shape or sharpen single teeth if used in a crisscross pattern. The single point grinding wheel can also sharpen a single edge of a tooth on a single plunge. The grinding wheel is rotated by drive shaft 64 and has a surface 66 on which the blade or piece of metal can rest while being fed into the grinding wheel.

FIG. 7 is a perspective view of an alternative embodiment of a rotary grinding wheel wherein removable guard 68 can be used as a blade rest or be removed to gain access to the single point grinding wheel 70. Single point grinding wheel 70 is used to remove old teeth, sharpen individual blade teeth or forward angle teeth on reciprocating, oscillating or circular saw blades. Also, the outward facing angled edge of the single point grinding wheel can be used to remove old teeth.

Abrasive is added to the exterior flat surface of the single point grinding wheel 70 to allow for drill bit sharpening. Slot 78 allows access to the straight part of grinding wheel 76 which can be used to remove old teeth or change the overall shape of the blade.

Grinding wheel 76 is used to create a plurality of teeth. The staggered design allows various sized teeth to be created. It also allows for more or less teeth to be created along a blade’s cutting edge.

In some embodiments, the single point grinding wheel 70 has a flat and thin profile. This design facilitates the sharpening of a single edge of many forward angled teeth compared to the V shaped single point grinding wheel. The thin profile fits in the narrow slot between forward angled teeth where the thicker V shape will not fit.

FIG. 8 is a perspective view of an alternative embodiment of a rotary grinding wheel with the single point grinder 70 removed while the safety guard 68 is still affixed.

FIG. 9 is a side view of an alternative embodiment of a rotary grinding wheel with the single point grinder 70 removed while the safety guard 68 is still affixed.

FIG. 10 is a perspective view of the single point grinder 70 wherein the inverted “V” shape allows for grinding individual teeth and custom shaped teeth.

It will be apparent to those skilled in the art that changes and modifications may be made in the embodiments illustrated, without departing from the spirit and scope of the invention. Thus, the invention is not to be limited to the particular forms herein shown and described except insofar as indicated by the scope of the appended claims.

### OTHER EMBODIMENTS

Although the present subject matter has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present subject matter.

### DESCRIPTION OF THE FIGURES

FIG. 1 is a side view of a rotary grinding wheel for shaping and sharpening saw blade teeth.

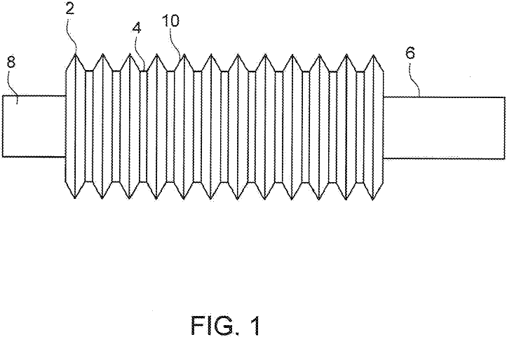

FIG. 2 is a side view of the rotary grinding wheel for shaping and sharpening saw blade teeth from FIG. 1 along with a side view of a saw blade after one pass with the rotary grinding wheel.

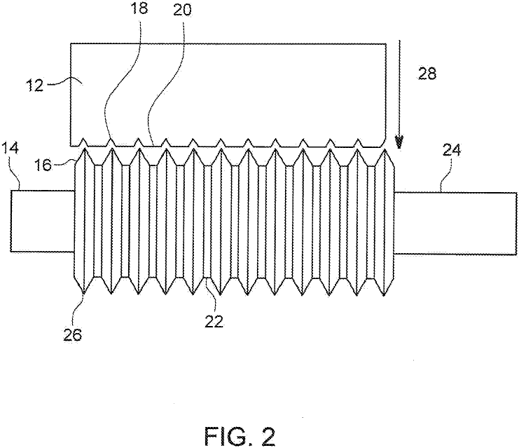

FIG. 3 is a side view of the rotary grinding wheel for shaping and sharpening saw blade teeth from FIG. 1 along with a side view of a saw blade after two passes with the rotary grinding wheel.

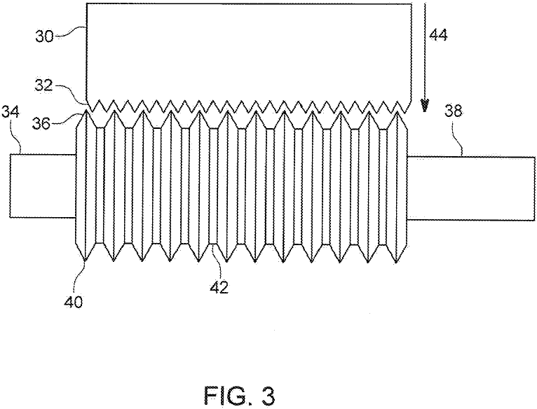

FIG. 4 is a side view of an alternative embodiment of a rotary grinding wheel for shaping and sharpening saw blade teeth.

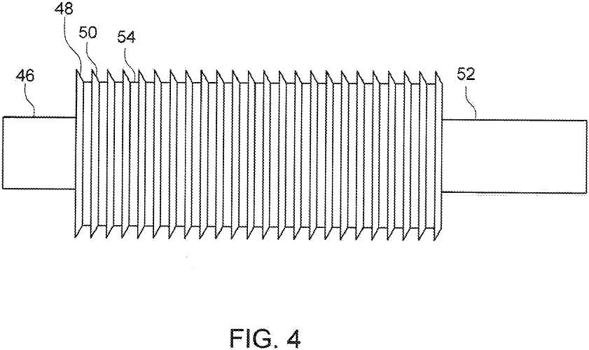

FIG. 5 is a side view of an alternative embodiment of a rotary grinding wheel for shaping and sharpening saw blade teeth in one pass.

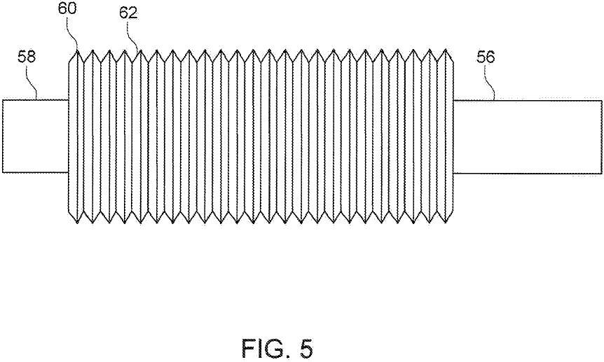

FIG. 6 is a front view of an alternative embodiment of a rotary grinding wheel with a single point grinding wheel.

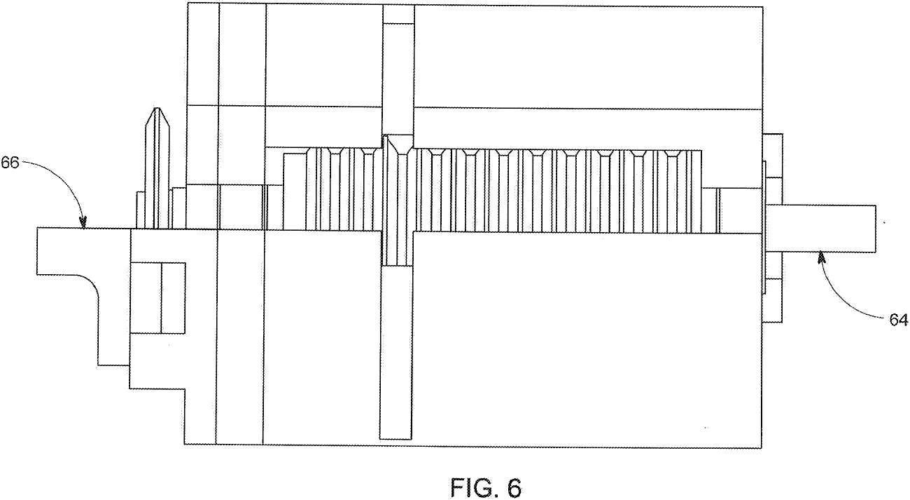

FIG. 7 is a perspective view of an alternative embodiment of a rotary grinding wheel.

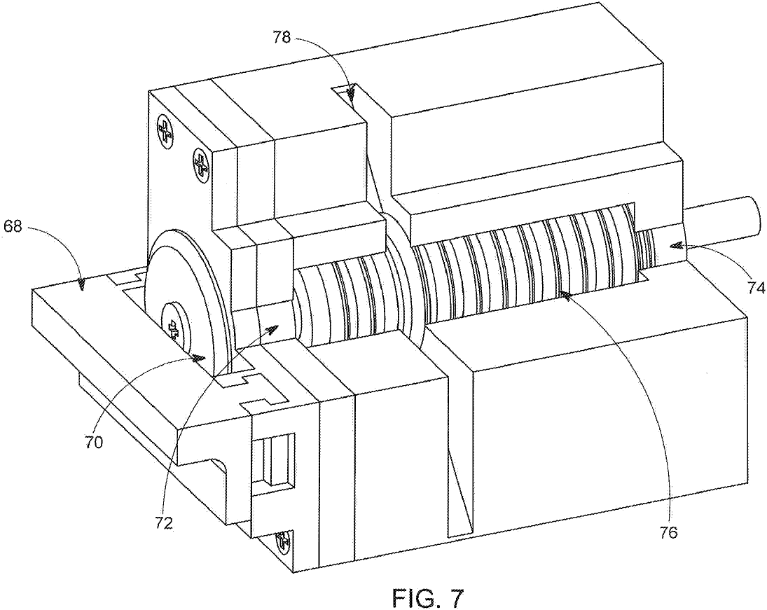

FIG. 8 is a perspective view of an alternative embodiment of a rotary grinding wheel with the single point grinder removed while the safety guard is still affixed.

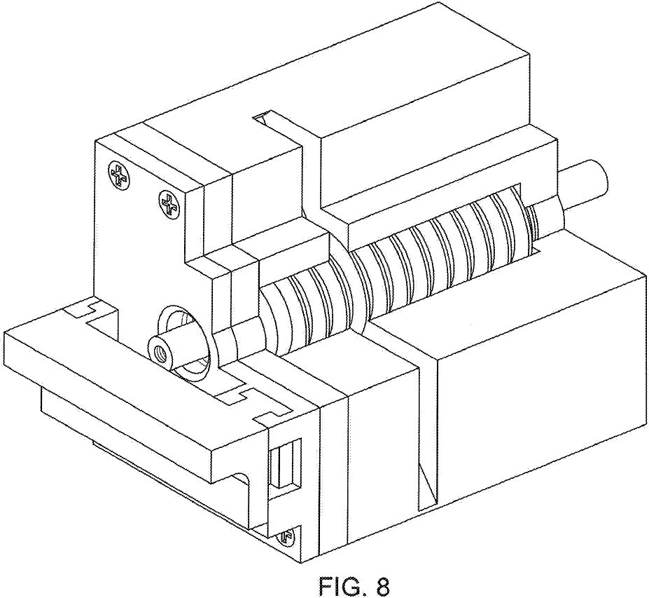

FIG. 9 is a side view of an alternative embodiment of a rotary grinding wheel with the single point grinder removed while the safety guard is still affixed.

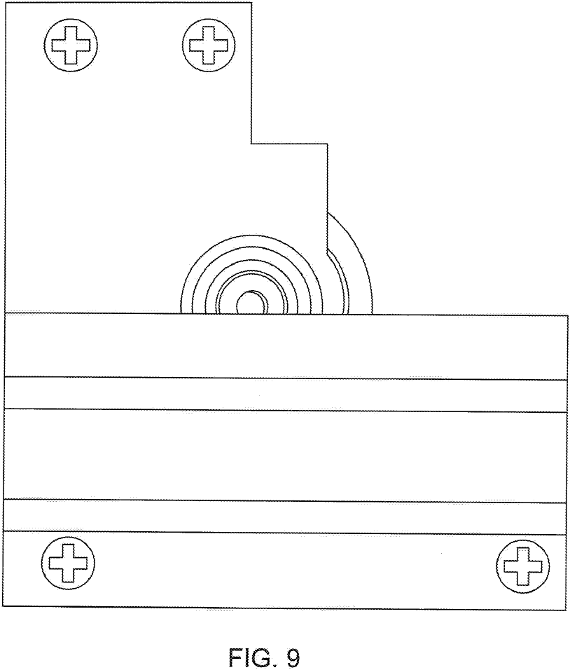

FIG. 10 is a perspective view of the single point grinder.

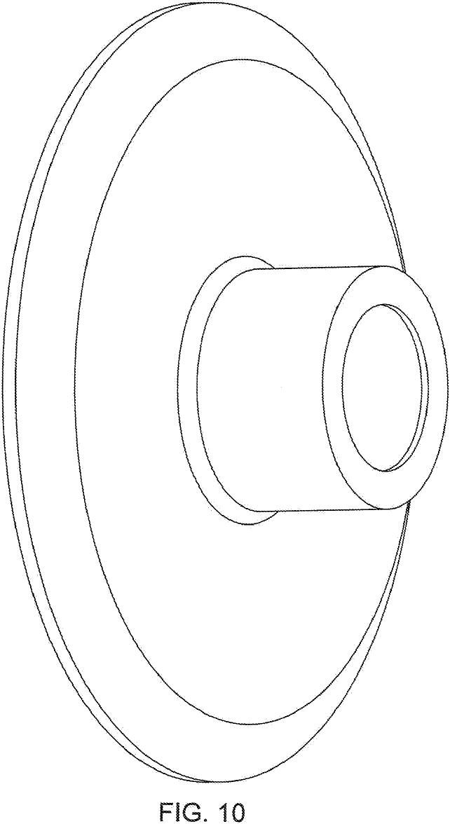

### DRAWINGS --- REFERENCE NUMERALS

2 grinding blades
4 body
6 shank
8 rotary grinding wheel
10 angular surface
12 blade
14 rotary grinding wheel
16 angular surface
18 tooth
20 space
22 body
24 shank
26 grinding blades
28 arrow
30 blade
32 teeth
34 rotary grinding wheel
36 angular surface
38 shank
40 grinding blades
42 body
44 arrow
46 support
48 grinding blades
50 angular surface
52 shank
54 body
56 shank
58 rotary grinding wheel
60 grinding blades
62 angular surfaces
64 drive shaft
66 flat surface
68 removable guard
70 single point grinding wheel
72 bearing
74 bearing
76 grinding blades
78 slot

We claim:

1. An apparatus for sharpening saw teeth comprising of a rotary grinding wheel, a plurality of grinding blades, body, angular surfaces, shank, an abrasive, a single point grinding wheel, a removable guard, a slot, and motor.

2. The apparatus for sharpening saw teeth comprising of a rotary grinding wheel, a plurality of grinding blades, body, angular surfaces, shank, the abrasive, the single point grinding wheel, the removable guard, the slot, and motor as in claim 1, wherein the rotary grinding wheel is mounted to the shank.

3. The apparatus for sharpening saw teeth comprising of a rotary grinding wheel, a plurality of grinding blades, body, angular surfaces, shank, the abrasive, the single point grinding wheel, the removable guard, the slot, and motor as in claim 1, wherein the motor spins the rotary grinding wheel at a speed necessary for shaping saw blade teeth.

4. The apparatus for sharpening saw teeth comprising of a rotary grinding wheel, a plurality of grinding blades, body, angular surfaces, shank, the abrasive, the single point grinding wheel, the removable guard, the slot, and motor as in claim 1, wherein the plurality of grinding blades are dispersed evenly on the body in such a way that the grinding blades correspond to one side of the desired saw blade teeth.

5. The apparatus for sharpening saw teeth comprising of a rotary grinding wheel, a plurality of grinding blades, body, angular surfaces, shank, the abrasive, the single point grinding wheel, the removable guard, the slot, and motor as in claim 1, wherein the angular surfaces are coated in the abrasive.

6. The apparatus for sharpening saw teeth comprising of a rotary grinding wheel, a plurality of grinding blades, body, angular surfaces, shank, the abrasive, the single point grinding wheel, the removable guard, the slot, and motor as in claim 1, wherein angular surfaces are on both sides of the grinding blades to form and sharpen a full set of saw teeth in a single pass.

7. The apparatus for sharpening saw teeth comprising of a rotary grinding wheel, a plurality of grinding blades, body, angular surfaces, shank, the abrasive, the single point grinding wheel, the removable guard, the slot, and motor as in claim 1, wherein the single point grinding wheel allows for the grinding of individual teeth and custom shaped teeth.

8. A method of using an apparatus for sharpening saw teeth comprising of a rotary grinding wheel, a plurality of grinding blades, body, angular surfaces, shank, an abrasive, a single point grinding wheel, a removable guard, a slot, and motor.

9. The method of using the apparatus for sharpening saw teeth comprising of a rotary grinding wheel, a plurality of grinding blades, body, angular surfaces, shank, the abrasive, the single point grinding wheel, the removable guard, the slot, and motor as in claim 7, wherein the rotary grinding wheel is mounted to the shank.

10. The method of using the apparatus for sharpening saw teeth comprising of a rotary grinding wheel, a plurality of grinding blades, body, angular surfaces, shank, the abrasive, the single point grinding wheel, the removable guard, the slot, and motor as in claim 7, wherein the motor spins the rotary grinding wheel at a speed necessary for shaping saw blade teeth.

11. The method of using the apparatus for sharpening saw teeth comprising of a rotary grinding wheel, a plurality of grinding blades, body, angular surfaces, shank, the abrasive, the single point grinding wheel, the removable guard, the slot, and motor as in claim 7, wherein the plurality of grinding blades are dispersed evenly on the body in such a way that the grinding blades correspond to one side of the desired saw blade teeth.

12. The method of using the apparatus for sharpening saw teeth comprising of a rotary grinding wheel, a plurality of grinding blades, body, angular surfaces, shank, the abrasive, the single point grinding wheel, the removable guard, the slot, and motor as in claim 7, wherein the angular surfaces are coated in the abrasive.

13. The method of using the apparatus for sharpening saw teeth comprising of a rotary grinding wheel, a plurality of grinding blades, body, angular surfaces, shank, the abrasive, the single point grinding wheel, the removable guard, the slot, and motor as in claim 7, wherein angular surfaces are on both sides of the grinding blades to form and sharpen a full set of saw teeth in a single pass.

14. The method of using the apparatus for sharpening saw teeth comprising of a rotary grinding wheel, a plurality of grinding blades, body, angular surfaces, shank, the abrasive, the single point grinding wheel, the removable guard, the slot, and motor as in claim 7, wherein the single point grinding wheel allows for the grinding of individual teeth and custom shaped teeth.

15. A method of constructing an apparatus for sharpening saw teeth comprising of a rotary grinding wheel, a plurality of grinding blades, body, angular surfaces, shank, an abrasive, a single point grinding wheel, a removable guard, a slot, and motor.

16. The method of constructing the apparatus for sharpening saw teeth comprising of a rotary grinding wheel, a plurality of grinding blades, body, angular surfaces, shank, the abrasive, the single point grinding wheel, the removable guard, the slot, and motor as in claim 13, wherein the rotary grinding wheel is mounted to the shank.

17. The method of constructing the apparatus for sharpening saw teeth comprising of a rotary grinding wheel, a plurality of grinding blades, body, angular surfaces, shank, the abrasive, the single point grinding wheel, the removable guard, the slot, and motor as in claim 13, wherein the motor spins the rotary grinding wheel at a speed necessary for shaping saw blade teeth.

18. The method of constructing the apparatus for sharpening saw teeth comprising of a rotary grinding wheel, a plurality of grinding blades, body, angular surfaces, shank, the abrasive, the single point grinding wheel, the removable guard, the slot, and motor as in claim 13, wherein the plurality of grinding blades are dispersed evenly on the body in such a way that the grinding blades correspond to one side of the desired saw blade teeth.

19. The method of constructing the apparatus for sharpening saw teeth comprising of a rotary grinding wheel, a plurality of grinding blades, body, angular surfaces, shank, the abrasive, the single point grinding wheel, the removable guard, the slot, and motor as in claim 13, wherein the angular surfaces are coated in the abrasive.

20. The method of constructing the apparatus for sharpening saw teeth comprising of a rotary grinding wheel, a plurality of grinding blades, body, angular surfaces, shank, the abrasive, the single point grinding wheel, the removable guard, the slot, and motor as in claim 13, wherein angular surfaces are on both sides of the grinding blades to form and sharpen a full set of saw teeth in a single pass.

21. The method of constructing the apparatus for sharpening saw teeth comprising of a rotary grinding wheel, a plurality of grinding blades, body, angular surfaces, shank, the abrasive, the single point grinding wheel, the removable guard, the slot, and motor as in claim 13, wherein the single point grinding wheel allows for the grinding of individual teeth and custom shaped teeth.
